(19) United States
(12) Patent Application Publication
(10) Pub. No.: US 2008/0306877 A1
(43) Pub. Date: Dec. 11, 2008

(54) Secure Internet E-Commerce

(76) Inventors: Meir Mandeles, Nirit (IL); Lilach Mandeles, Nirit (IL)

Correspondence Address: JOHN ALEXANDER GALBREATH, 2516 CHESTNUT WOODS CT, REISTERSTOWN, MD, 21136, US

(21) Appl. No.: 12/064,366

(22) PCT Filed: Aug. 22, 2006
(86) PCT No.: PCT/IL2006/000948

§ 371 Date: Feb. 21, 2008

Related U.S. Application Data
(60) Provisional application No. 60/709,831, filed on Aug. 22, 2005.

(51) Int. Cl. G06Q 30/00

(52) U.S. Cl. 705/76

(57) ABSTRACT

A secure Internet based website electronically facilitating Internet entry of an account-owner to a pre-registered account on the secure Internet based website; escorting the owner to a merchant Internet site and therewith transmitting to the merchant site a one-time password, wherein said one-time password is thereafter identifiable by the secure Internet based website; receiving an invoice from the merchant Internet site wherein said invoice includes the one-time password; validating the one-time password; and presenting the invoice to the account owner. Now, if the secure Internet site receives an invoice approval from the owner, then the secure Internet site electronically providing the merchant Internet site with payment and delivery details necessary to complete a commercial agreement between the owner and the merchant wherein said agreement corresponds to specification, terms, and conditions associated with the invoice.

This application claims priority to provisional U.S. Provisional Application Ser. No. 60/709,831, filed Aug. 22, 2005.

### FIELD OF THE INVENTION

The present invention generally relates to Electronic Commerce transactions carried out over the Internet. More specifically, the present invention relates to permitting a buyer, party to such transactions, an improved degree of personal information security and transaction management control.

### BACKGROUND OF THE INVENTION

In today's age of electronic commerce over Internet, there are many simplified secure systems for arranging the funds transfer; most often used in the context of a buyer seller relationship, albeit also occurring in intra-user funds transfer arrangements, transactions involving conversions of currency or of “commercial paper”, and the likes. Each of the many systems for configuring such transaction events is concerned with privacy, security, robust aspects, auditing provisions, and ease of use.

Typically, a consumer-merchant go-between service arranges payment transfer from the consumer to the merchant—by the go-between accepting the payment from the consumer and then transferring the payment to the merchant. In the course of this go-between “handshake” there is ample opportunity for the merchant to collect information about the consumer—including electronic contact information (e.g. email address) and/or physical geographic contact information (e.g. address and telephone). Once collected, the merchant may bother the consumer or sell this information—thereby allowing others to bother the consumer.

There are, of course, older variations of this scenario, which have been used for inter-bank electronic funds transfers and for more recent sorts of electronic commerce arrangements; such as those used in the “trading” of stocks, bonds, commodities, and the likes. Essentially, all of these systems are being scaled down to the use of ordinary consumers in the course of their respective internet commerce activities; including the purchase of goods, the ordering of services, the downloading of electronic media and/or data, etc.

In the context of these consumer-scaling electronic commerce processing methods and activities are a number of noteworthy systems for configuring such transactions.

U.S. Pat. No. 5,710,887 (by Broadvision) relates to a system for facilitating commercial transactions, between a plurality of customers and at least one supplier of items over a computer driven network capable of providing communications between the supplier and at least one customer site associated with each customer. Each site includes an associated display and an input device through which the customer can input information into the system. At least one supplier is presented on the display for selection by the customer using the input device. Similarly items from a supplier can be displayed for the customer to observe. Associated with a supplier of such items is an item database including information on presented items. Pricing subsystem receives information from the item database to determine the cost associated with a presented item. In addition a customer information database stores information relating to the customer. Associated with each customer is a customer-monitoring object for each customer. The customer-monitoring object is created by referencing information, relating to that customer, which had been stored in the customer information database and when the customer selects a supplier. The customer monitoring object is configured to operate by responding to customer enquiries regarding a presented item by retrieving information relating to the item and presenting the information to the customer; receiving a customer's selection of a presented item; receiving customer communications, indicating a desire to receive the item; and passing a communication to initiate the delivery of the item to the customer.

WO/2002/005231 (by PayPal) relates to a system and method for handling a payment between a buyer/payor and a seller/payee at a third-party site. The buyer is redirected from the seller to a third-party payment processor to process payment for an electronic transaction. Details of the transaction are received with the buyer's connection. The buyer may be electrically disconnected from the seller, thereby preventing financial or private data from being passed to the seller. The third-party payment processor establishes an account for the buyer, if one does not exist, which may be funded by a credit card, debit card or bank account. The account is identified with an electronic mail address or other unique identifier. The payment processor transfers payment from the buyer to the seller (e.g., through a seller account with the processor). The buyer may be redirected to the seller after completion or cancellation of payment.

WO/2002/005224 (by PayPal) relates to a system and method for verifying a financial instrument or a user's authorization to use a financial instrument. A transaction processor initiates one or more verifying transactions involving the instrument, with details that may vary from one transaction to another, such as the type of transaction (e.g., deposit, credit, debit), amount of the transaction, number of transactions, the merchant or vendor name or account for the transaction, and so on. Selected details, particularly variable ones, are saved in the system. The user accesses information regarding the transaction by accessing it on-line, via telephone, in a monthly statement, etc. The user then submits the requested details to the system through a user interface, which compares them to the stored details. If they correspond, then the user may be permitted to use the instrument (e.g., for a purchase, a funds transfer).

U.S. Pat. No. 6,609,113 (by the Chase Manhattan Bank) relates to a system and method for effectuating Electronic Funds Transfer credit messages. The main structural components of the system include a Payment Portal Processor (PPP), an Internet Pay Anyone (IPA) Account, a Virtual Private Lockbox (VPL) and an associated Account Reporter, the existing EFT networks, and a cash card for accessing a VPL or IP account. The PPP is a software application that provides a secure portal for accessing (linking to) either the user's Demand Deposit Account (DDA) or an IPA account and can be combined with the functionality of a traditional digital Wallet. Consumers use a PPP enhanced Wallet to fund their account, shop on the web, pay bills, pay anyone, store electronic receipts and transaction history, and check their recent PPP enhanced Wallet activity. The IPA account is a special purpose account with limited functionality for making electronic payments in the form of EFT credit messages. The VPL is a limited function receive-only account for receiving electronic payments through the EFT. The Account Reporter is a portal to view transaction history and balance of IPA and VPL accounts, provide online, real-time transaction reports, and to reconciles accounts receivable/purchase records against incoming EFT payment records. A physical card can be associated with either an IPA or VPL account in order to provide PIN debit capability.

U.S. Pat. No. 6,941,282 (by Oracle International Corporation) relates to computer-implemented methods and systems for securely carrying out electronic transactions including electronic drafts, wherein payment on at least one of the drafts is contingent upon the removal of an associated contingency. The method may include steps of establishing a secure computer site accessible only by authenticated parties to the transaction and by any authenticated contingency approver. The site includes a representation of the transaction that includes a representation of each of the plurality of drafts and an option to remove any contingencies associated therewith. Parties and contingency approvers requesting access to the computer site are authenticated by encrypting identification information provided by the requesting party or contingency approver over a secure channel and successfully matching the encrypted identification information with an encrypted identifier that is stored by a bank, the encrypted identifier being unique to the requesting party or contingency approver. Payment on the constituent drafts of the transaction are released by the bank only when the option to remove each contingency associated with the draft is timely exercised by an authenticated party or authenticated contingency remover that is authorized to remove the contingency. Complex transactions may thereby be carried out securely, remotely and without compromising personal and/or financial information. The invention obviates the need to disseminate identification surrogates such as credit card numbers over public networks as well as the need to rely upon in-person holographic signatures on paper documents for authentication purposes.

U.S. Pat. No. 7,031,939 (by Yahoo! Inc.) relates to systems and methods for effecting online financial transactions between individuals or between individuals and entities such as banks, merchants and other companies. Each user accesses a fund exchange server to establish an online account, which is used to transfer funds to and from other entities' online accounts. To fund an online account, funds can be transferred to the online account from a credit card account or from another online account. To withdraw funds, money can be transferred to a credit card account or other bank account. Any user may initiate a send money transaction or a request payment transaction with any other entity provided that entity has an e-mail address. For a send money transaction, the user sending money (payor) enters an amount of funds to be transferred and an e-mail address of the recipient of the funds (payee). The system sends an e-mail message to the payee at the address provided indicating that the amount of funds has been “received” on the payee's behalf. The payee must then either open an online account or identify an existing online account to complete the transaction. For a request money transaction, a user enters an amount of funds owed and an e-mail address for the recipient of the payment request (payor), and the system sends a payment request to the payor via e-mail at the provided address. If the payor accepts the payment request, the payor identifies an online account from which to transfer funds to the payee (initiator of the payment request). If the payor does not have an online account established, the payor must sign up for an online account and provide a credit card number to fund the online account. Thereafter, the amount of funds are transferred to the payee and the system sends an e-mail notification to the payee indicating that the funds have been “received” on the payee's behalf. In both cases, to complete a transaction, the payee must direct the received funds to an online account, for example, by providing an online account number and/or other identifying information such as a password. The payor may cancel the transaction at any time until the payee directs the received funds to an online account.

Now, while acknowledging that each of these prior art systems represents an improvement over their respective prior art for some user need driven sector of the electronic commerce marketplace, there remains a substantially unresolved area where the ease of use must converge with the management of privacy. Ongoing examples of this problem include unsolicited contacts from a seller to a buyer after a buyer visit to the seller site—often even in the case where the buyer did not make any purchase, however also including seller follow-up offers to sell something after the buyer has made at least one purchase there. Of course, some times the visitor or buyer is interested in such unsolicited messages—so there is a need in the art to allow the internet shopper to control the trail of identity traces that he leaves at the various sites that he visits or shops at.

Simply stated, there is a long felt need for ordinary Internet wanderers to have an easy way to take advantage of the convenience of internet commerce without loosing control over their identity and without opening the flood gates of unwanted solicitations either. More specifically, in all of the above-mentioned systems, the seller may make use of identity factors of prospective buyers, and actual buyers—just by virtue of their having visited the seller's Internet site. Likewise, ordinary funds transfer systems will encounter this same risk to the buyer if these systems were migrated to buyer with seller interaction scenarios. Another more recent problem for consumers relates to facile management of content (music, movies, pictures, etc.) purchased online wherein the consumer increasingly restricts himself from buying from new vendors—because the general consumer time overhead to initiate a new buyer-seller relationship is more tedious than the benefit that the consumer expects to enjoy form his initial purchases at the new vendor. Yet another recently emerging problem for the incidental consumer relates to desires for very occasional use of generally expensive software packages—where the potential of online rental still presents complexities of registration, audited use, security, privacy, etc.

### BRIEF SUMMARY OF THE INVENTION

The aforesaid longstanding needs are significantly addressed by embodiments of the present invention, which specifically relates to a Secure Internet E-Commerce Method. The instant method (including novel appurtenances and/or protocol used therewith) is especially useful in internet electronic commerce transaction processing interactions wherein there exists a longstanding need for preserving consumer privacy and/or for helping the consumer to better manage his budget for goods and services; which may be discovered and purchased (or rented) via the Internet.

The instant invention relates to embodiments of A Secure Internet E-Commerce Method, for improved consumer convenience managing of transactions, and the system includes:
(A) a secure Internet based website electronically facilitating Internet entry of an account-owner to a pre-registered account on the secure Internet based website;
(B) the secure Internet based website electronically escorting the owner to a merchant Internet site and therewith transmitting to the merchant site a one-time password, wherein said one-time password is thereafter identifiable by the secure Internet based website;
(C) the secure Internet based website electronically receiving an invoice from the merchant Internet site wherein said invoice includes the one-time password;
(D) the secure Internet based website electronically validating the one-time password;
(E) the secure Internet based website electronically presenting the invoice to the account owner; and
(F) if the secure Internet site receives an invoice approval from the owner, then the secure Internet site electronically providing the merchant Internet site with payment and delivery details necessary to complete a commercial agreement between the owner and the merchant wherein said agreement corresponds to specification, terms, and conditions associated with the invoice.

Now, lets walk through this embodiment and get a feel for how it works. The instant invention Secure Internet E-Commerce Method embodiment is for improved consumer convenience managing of transactions, which means that a customer (e.g. via a home computer or via an internet enabled mobile phone) is provided with an ability to visit electronic merchants, examine goods and services, place an order for such goods or services using a one-time password as a linkage key for unique identification of the order invoice and substantially all related thereto, manage his invoices (approval or reject thereafter—thereby providing the consumer with a distinct ability to manage his budget), and thereby protecting the consumer against unwanted communications from the merchant or his proxy or those with whom he may have shared or sold consumer contact details.

The first step of the system relates to (A) a secure Internet based website electronically facilitating Internet entry of an account-owner to a pre-registered account on the secure Internet based website. That means that there is a publicly accessible website (hereinafter referred to as “PCSite” when describing the preferred embodiment mode—as will be further described in the Detailed Description section) with a secure sign-in protocol that allows a user to access his account. The user account is substantially a private web-page (personal home page) where the user may accumulate links to many Internet sites, service, and tools. The user may have email, VoIP, and search engines from this site. The site may also be a gathering place for banners and targeted advertisements that the user allows (selectively permits) through a preferred embodiment of the instant invention.

OK, the second step of the system relates to (B) the secure Internet based website electronically escorting the owner to a merchant Internet site and therewith transmitting to the merchant site a one-time password, wherein said one-time password is thereafter identifiable by the secure Internet based website. By this step, the user has a means for the merchant to return to the user with an invoice or with other communications. Substantially, the one-time password is a manageable pseudonym (A fictitious name or “pen” name) that protects the user's identity—to whatever degree that the user prefers. Simply stated, a user who wants to end contact from the merchant will cancel the one-time password. For practical purposes, each such password is preferably associated with a singe invoice. Accordingly, the user may elect to append a more general pseudonym to the one-time password—thereby allowing transactions and/or communications to be grouped.

The third step of the system relates to (C) the secure Internet based website electronically receiving an invoice from the merchant Internet site wherein said invoice includes the one-time password. By this step, the PCSite (and its variants) has a facile means for forwarding the invoice to the user when coordinated with the fourth step of the system; relating to (D) the secure Internet based website electronically validating the one-time password. An invalid password will kick the accompanying communications and/or invoice into the great virtual electronic trash bin.

The fifth step of the system relates to (E) the secure Internet based website electronically presenting the invoice to the account owner. Preferably, this presentation is in the context of the accounts owner's personal website or PCSite. According to other variations of the instant invention, the presentation may be an invoice or email forwarding service.

The sixth (final) step of the system relates to (F) if the secure Internet site receives an invoice approval from the owner, then the secure Internet site electronically providing the merchant Internet site with payment and delivery details necessary to complete a commercial agreement between the owner (user) and the merchant wherein said agreement corresponds to specification, terms, and conditions associated with the invoice.

Now, according to principal embodiments of the instant invention, all that a customer (coming to buy online) needs from the online store is a receipt with details to identify all of the transaction particulars; including what is purchased, where to pay, where to ship, etc. Between the buyer and seller there is a mid-ware a merchant site. In the merchant site—the buyer enters with an ID and a unique one time facilitation site (PCSite) where the buyer enters his personal site—and goes out from his personal site to Password—(The ID may be saved by the merchant so as to provide better service as identified customer on future visits) The merchant saves the ID & Password for check-out event; such that at checkout, buyer allows the merchant to send an invoice to the buyer personal site. Thereafter, on the personal site, the user will review the invoice and approve or reject final purchase approval. If approved, then the user site supplies shipping address and other details to merchant and facilitates payment. Now, since the merchant to buyer communications is constrained to the pseudonym of the Password, the merchant may expect to communicate with the buyer either to provide the invoice for approval—or with a one-time packet of junk.

It should be noted that the “one-time password” is strictly speaking a one-time generated password—having a low probability of being regenerated and a less than infinitesimal probability of being guessed. Once the password has been generated, it is used as a common identifier to unify a merchant with a customer-visit—the details of which are included in an invoice that is identified by this same password. If the customer wishes to maintain a longer relationship with the merchant, then there are a number of ways of doing that. The customer may re-use the one-time password (not recommended). The user may append an Identification field to the password—changing the password on each visit to the merchant—but keeping the Identification constant (recommended). The user may arrive at a sufficient level of confidence in the merchant that the user will provide the merchant with unambiguous direct contact information (rare). Essentially the one time PW is a common search term between the buyer and seller data-base—to recover all related to his transaction information. Furthermore, in the context of the instant invention, a protocol that arranges or organizes for a substitution of the password for another password, entry pass, classified or unique key, personal hyperlink, data base record identifier, or the likes is substantially a further use of the password per se—and for purposes of logical consistency should be considered as if it were that password.

Another use of the password is for real time Content management acquisition—since the password lets the heretofore identified buyer re-enter (return to) a seller site to re-new content, continue with a purchase (adding or deleting details). Content management includes music downloads, movies, demos, other digital content, active media, programs, or protocols where the user can proceed via his PCSite to contact the content seller, request to download a content item, flip back to the personal site (e.g. alt-tab—to open a double window) and instantly approve the invoice. The method of the present invention may be implemented for a mobile phone—or other cellular device—or by RFID-to-browser 1-IR handshake—SMART-RFID or the likes—all of which constitute a secure protocol to enter the Personal Site “PCSite” of the instant invention. Together, these aspects allow a user to contact a radio or TV station content management seller—and in real time—buy or rent a copy of content that is being (or just was) broadcast, or to make contact with a seller who just ran an advertisement.

To conclude the items of the brief summary above, we will now briefly recite further advantages, objects, and benefits of the invention—linking them to specific technical, ergonomic and related economic features of the invention.

Technical Issues: Embodiments of the instant invention enable secure e-commerce Internet transactions while simultaneously preserving many aspects of consumer privacy. A key aspect of the principle embodiments of the instant invention provides a one-time password to link a consumer visit request for transaction with an invoice received by a consumer's personal transaction management facilitator. Accordingly, contact activity (e.g. spam, unsolicited offer emails, etc.) from the merchant site to the consumer may be easily filtered—as soon as the one-time password has expired.

There is also an elegant element of developmental simplicity in the preferred instant embodiment—as can be readily appreciated from the following Pseudo code for PCSite:

On PCSite server (An account owner navigate from his site to a
merchant site)

Rnd = Generate a random string
Register Rnd to database
Navigate to merchant site with Rnd as parameter

On merchant's server

Gets user request's parameter
Keep it as Session parameter

(On check out)
Send an invoice to PCSite with Rnd
On PCSite server

Check if the invoice and the parameter are valid
If not valid then delete invoice and ignore it
If the invoice is valid then

Register it in the database
Display it to the user

If the user choose to pay the invoice then

Transfer money to the merchant
Send the merchant a shipping address

If the invoice is not of a physical product (content)

Register the content site URL and Rnd to the database
Display the content site in a dedicated list on the user site as a link
On click that link
Open a browser and navigate to the content site with the registered
Rnd

On the content site

Check if the Rnd is registered (the invoice is paid)
If it is registered then

Redirect the user to the content page

Ergonomic Issues: Firstly, embodiments of the instant invention enable secure Internet e-commerce transactions via home computer terminal and via cell phone enabled with Internet. Secondly, these embodiments elevate level of e-commerce services to be easier to use, faster, and simpler. According to these instant embodiments, such transactions have more innate security, are less time consuming, and create a more facile management of content purchases. Another clear advantage is that embodiments of the instant invention free the ordinary user from the burden of remembering, managing, and changing countless internet site specific passwords. Essentially, embodiments of the instant invention create one-time passwords for each potential internet commerce transaction invoice, and provide simple straightforward semi-automatic (user rule based parameter) management thereof. Furthermore, the personal site “PCSite” of the present invention provides a facility to record and securely store & actualize site specific passwords.

Economic Issues: Secure Internet e-commerce according to the instant invention provides an easy interface for the coordination of consumer budget with invoice approvals. This feature is especially useful for the management of content subscriptions (e.g. e-magazines, video streams, groupware electronic games, etc.).

Please note that the present invention is herein described with a certain degree of particularity, however those versed in the art will readily appreciate that various modifications and alterations may be carried out without departing from either the spirit or scope, as hereinafter claimed. Furthermore, in describing the present invention, explanations are presented in light of currently accepted Scientific, Technological or Mercantile theories and models. Such theories and models are subject to changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the following description in consideration of the accompanying drawings, in which like reference numbers indicate like features and wherein

FIG. 1 illustrates a schematic view of a general embodiment of the Secure Internet E-Commerce Method; and

FIGS. 2-6 illustrate key event demonstration Screen Shots of a user interface as seen during a typical PCSite session.

### DETAILED DESCRIPTION OF THE INVENTION

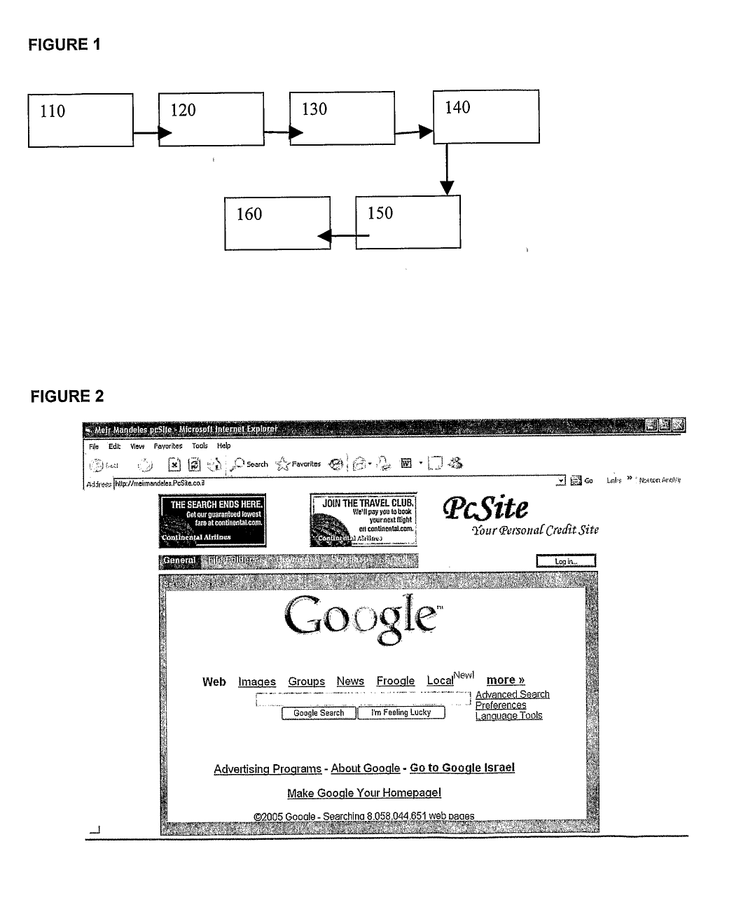

Embodiments and aspects of the instant invention may be embodied in various non-limiting example forms. Turning to FIG. 1, the instant invention relates to embodiments of A Secure Internet E-Commerce Method, for improved consumer convenience managing of transactions, and the system includes:

(A) a secure Internet based website electronically facilitating 110 Internet entry of an account-owner to a pre-registered account on the secure Internet based website;
(B) the secure Internet based website electronically escorting 120 the owner to a merchant Internet site and therewith transmitting to the merchant site a one-time password, wherein said one-time password is thereafter identifiable by the secure Internet based website;
(C) the secure Internet based website electronically receiving 130 an invoice from the merchant Internet site wherein said invoice includes the one-time password;
(D) the secure Internet based website electronically validating 140 the one-time password;
(E) the secure Internet based website electronically presenting 150 the invoice to the account owner; and
(F) if the secure Internet site receives an invoice approval from the owner, then the secure Internet site electronically providing 160 the merchant Internet site with payment and delivery details necessary to complete a commercial agreement between the owner and the merchant wherein said agreement corresponds to specification, terms, and conditions associated with the invoice.

According to a first variation embodiment of the Secure Internet E-Commerce Method, electronically facilitating Internet entry of an account-owner to a pre-registered account on the secure Internet based website includes validating of an account owner password or of a biometric. There are other ways to validate the account owner and thereby permit him access to “his” account”, PCSite, etc. For example, validation might be performed on an RFID tag that has been authorized to be synonymous with the account owner. If this is proved acceptable, then the validation might allow a reduced threshold, such as by a credit card or by an automated analysis of a signature image, etc. In this variation, some aspects of fleet management might be performed (e.g. via RFID or even optical license recognition) to allow payment for fuel, road-side services, tolls, and the likes.

According to a second variation embodiment of the Secure Internet E-Comrnerce Method, electronically escorting the owner to a merchant Internet site includes the secure Internet based website electronically exchanging information with the merchant Internet site. This information might be useful in the context of the secure private invoices. However, this feature is also useful per se for the provision of other commercial handshake opportunities between the secure website and the merchant site; for example, in the sharing of user profile data to help the merchant present appropriate merchandise to the user, the transfer of banners or targeted advertisements to the secure website to help present appropriate (user approved) follow-up opportunities to the user, for the negotiation of discounts or rebates or commissions, and the likes.

According to a third variation embodiment of the Secure Internet E-Commerce Method, transmitting the one-time password includes appending a data portion selected from the list: an account owner identifier (e.g. passport number, social security number, drivers license number, health organization membership number, etc.), a password date stamp (indicating the data that the password was created), a password expiration date, a password validity duration metric (suggesting a relative status of communications associated with this password—a sort of volatility measure—indicating importance to the account owner), an account owner profile, an account owner credit description, a secure Internet based website rebate descriptor, a secure Internet based website commission descriptor, a secure Internet based website transaction fee descriptor, a secure Internet based website follow-up ID, and the likes.

According to a fourth variation embodiment of the Secure Internet E-Commerce Method, receiving an invoice from the merchant Internet site includes receiving a transaction parameter portion selected from the list: a merchant Internet site identifier, an invoice date stamp, an invoice expiration date, an invoice validity duration metric, a merchant Internet site profile, merchant Internet site credit description, a merchant Internet site rebate descriptor, a merchant Internet site commission descriptor, a merchant Internet site transaction fee descriptor, and a merchant Internet site follow-up ID. This facility essentially allows a full cycle of peripheral data exchange between the owner and the merchant site—if desired.

According to a fifth variation embodiment of the Secure Internet E-Commerce Method, electronically presenting the invoice to the account owner include electronically presenting a follow-up notice from a merchant site wherein the account owner has established a predetermined allowance (permission) to receive such a notice.

According to one enhancement of the fifth variation embodiment of the Secure Internet E-Commerce Method, electronically presenting a follow-up notice includes forwarding an email (or SMS via telephone, etc.) from the merchant to the account owner.

According to another enhancement of the fifth variation embodiment of the Secure Internet E-Commerce Method, electronically presenting a follow-up notice includes placing a merchant advertisement (also notices, announcements, or coupons) on an account owner WebPage of the secure Internet based website.

According to a sixth variation embodiment of the Secure Internet E-Commerce Method, providing the merchant Internet site with payment and delivery details necessary to complete a commercial agreement between the owner and the merchant includes providing account owner approved personal data or answering a merchant survey or answering a merchant satisfaction follow-up questionnaire, or the likes.

According to a seventh variation embodiment of the Secure Internet E-Commerce Method, electronically escorting the owner to a merchant Internet site includes electronically accessing a real-time schedule of media content to media content rights merchant contact data—so that the owner can rent or purchase (or visit a website in order to use) a copy of media content (or of a site or of a site selection) substantially as it was presented on a media selected from the list: transmission television, encrypted television, cable television, transmission radio, encrypted radio, cable radio, and cellular telephone data feed. For example, a user hearing a song on his TV may communicate with the TV station website to access a content management index from which the user may arrange for a purchase of a copy of that song.

According to an eighth variation embodiment of the Secure Internet E-Commerce Method, electronically escorting the owner to a merchant Internet site includes electronically accessing a software content rights merchant's contact data—so that the owner can rent or purchase a copy of software content, executable code, or data usable therewith. This means that the one time password (after the invoice is paid) can be used as a entry permit for content access, usage, or the likes; preferably such that the invoice becomes the carrier of the entry parameter for the new “account” wherein the account entry permit is a link plus the onetime password. Preferably, further billing events from within the new account may proceed semi-automatically according to the instant method thereat. In general, the invoice link (plus one time password—having become a merchant site entry pass) becomes stored at the PCSite as a return path to access content on the seller site or to a seller directed site.

We will turn now to a non-limiting example of PCSite: concept and technology for secure Inter-site communication (Including money transactions) by using a Personal site.

Preferred embodiments of this invention pertain to a method of electronic commerce that is done on (via) the Internet. Specifically, it consists of commencing secure payment by electronic transactions between a consumer and an online merchant. The general instant invention embodiment method is based on four steps: First step: A consumer navigates to his own personal site. Second step: from his site the consumer navigates to an on-line merchant, identifying himself via a one-time password provided by the personal site. Third step: check out. The on line shop send an invoice to the consumers site using the identification parameters sent by the consumer. Step four: the consumer approves the invoice from within his site. The technology to support this electronic method for purchasing consists of a software module and a third party data processing service. The software module facilitates the aforementioned communication protocol for purchasing. The third party will receive the instruction from the consumer site to commence an electronic transaction. It will preferably either credit the online vendor directly or through a credit card company.

The invention preferred embodiment consists of three main parts: (A) a novel method part for purchasing on the internet, (B) a technology to facilitate the purchasing method part and (C) an optimization technology part that deals with the speed, ease and reliability of the interaction between any internet user and an online interactive homepage (including online vendors).

Recall: Current online purchasing on the Internet require a customer to submit electronically his personal credit card number and personal details into the online merchant's database. Two problems emerge from this procedure. First, the problem of security: The credit card number is stored in the electronic database of the online vendors. It is liable for theft and abuse by thieves and hackers. Second, the current purchasing procedure is time consuming: The consumer needs to type in secret numbers and other personal details. The steps in the process of the current purchasing on the Internet generally include a purchasing process on the Internet wherein the consumer informs his intention to buy a product and submit his credit card number; and therein or thereafter the online vendor contacts the credit company and requests an authorization

PCSite (Personal Credit Site) uses Internet tools In the Internet era by forming a consumer credit site (instead of credit card) with a unique URL on the web. The credit site contains substantially all consumer details (Bank account, Email, Shipping address . . . ). Preferably, a PCSite Corporation hosts these personal consumers' sites and manages all interactions between the merchant's web sites and their consumers. By using this approach, many security issues are solved, and the purchase process become shorter and user-friendly. Essentially PCSite create new-GUI purchase methods.

How dose PCSite work? On all current credit card payment systems, the merchant's web sites receive all the data it needs to charge the consumer bank account. On PCSite payment method, the action of payment is transferred from the merchant's web sites to the consumer site. The merchant's web site is supplied only with the consumer PCSite name and it uses it to send an invoice of the requested amount of money to the consumer site. The consumer can then navigate to his site and decide whether to pay or not to pay the invoice just arrived. If the consumer chooses not to pay, the merchant's web sites receive a cancel message. If the consumer chooses to pay, the consumer bank account is charged, the money is deposit on the merchant's bank account and the merchant's web site receives a message saying “the invoice is paid, send goods to <shipping address>.”

Since the consumer User name is public (there is no attempt to hide it) the consumer site might be filled up with junk invoices, just like junk Emails. To prevent this from happening there must be an invoice authorization policy on PCSite system. Meaning, the merchant's web site, in order to be able to send an invoice, must be supplied with a valid password. This password is generated on PCSite system as a result of the consumer request, and its send to the merchant's web site, that use it to send its invoice. After the invoice is sent the password became invalid and can't be use on PCSite system ever again.

PCSite data flow steps (hereinafter) summarize the actions that take place in the purchase process.
Step 1. On the merchant's web sites, on the check out process a popup window appears requesting the consumer to type his PCSite name.
Step 2. The consumer navigates to PCSite system by clicking the “Authorize vendor” link
Step 3, 4. By applying this form (after authentication) PCSite system generates a disposable password and sends it to the merchant web site.
Step 5. Once the merchant web site receives the disposable password it sends an invoice to the consumer PCSite. The check out complete message appears after acknowledge from PCSite is received.
   At this point the merchant's web site is waiting for the invoice payment acknowledge. The consumer can pay the invoice by navigating to his PCSite on a more convenient time after second thought, or by clicking the link on the check out complete window. Both options open the payment window of the consumer PCSite.
Step 6. On this window the consumer can update his shipping address, and see again the purchased item details. In order to pay, a payment password must be supplied. After the invoice is paid, PCSite cop. deposits the money on the merchant's bank account and sends the merchant's web sites a payment acknowledge message with the shipping address and contact information.
   Note: The payment window is the only point on PCSite system that generates money transaction, and its totally controlled by the consumer.

It remains for us to distinguish between PCSite of the instant invention and Paypal (a common prior art internet payment method). In terms of logical concept PCSite is different from Paypal. Paypal acts as an intermediate between the consumer and the merchant web site. There is no connection between them and the data exchange is made through Paypal server.

When using PCSite, the merchant and the consumer web sites exchange data using a well defined protocol (no intermediates). In addition, when the consumer navigates the web from his one personal site (hosted by PCSite co.), a major differentiation would be the ability to be identified on the entrance to every site the consumer navigates to. Since PCSite provides a personal site to every consumer the consumers have more options. Essentially the Logical concepts of Paypal and PCSite are different.

The consumer web site supplied by PCSite is divided to three main sections
1. Public area: anyone can navigate to a given URL
2. Private area: in order to enter this section, a valid password must be supplied.
3. The payment window: as described before a payment password is required in order to generate money transaction

In addition, the web site will host advertisements that enable a purchase process even shorter then the process described above.

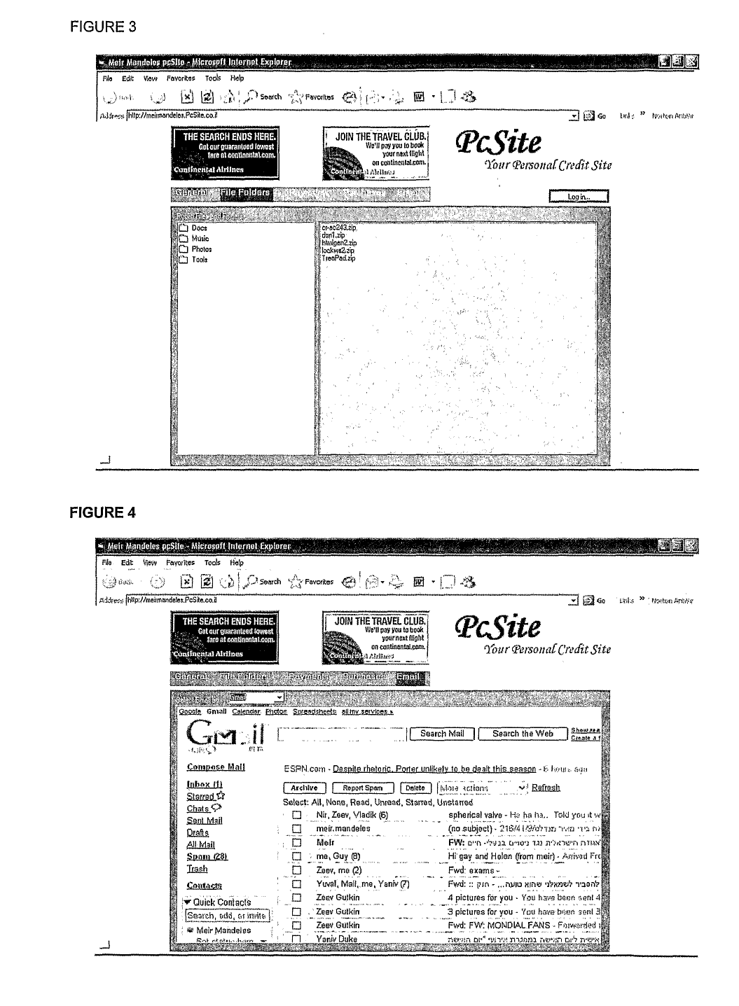

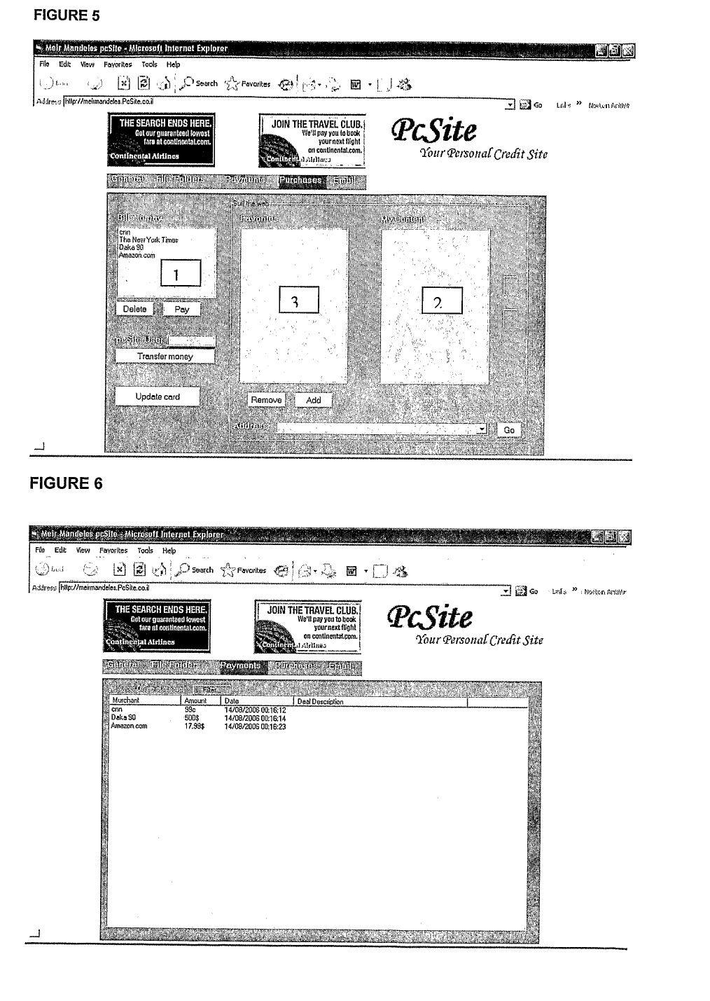

The public area contains sections for
1. Web browser (see FIG. 2), to enable the consumer to navigate on the web to its home page (Google.com).
2. File folders (see FIG. 3) the consumer defined as public. (Shared files and folders)
3. Blogs, and the likes.
   The private section contains sections for
1. File folders the consumer defined as private. (e.g. For Back-up purposes)
2. Multiple Email boxes (see FIG. 4) for different purposes. All managed from the same window with the same authorization level.
3. Money transaction history. Enable the consumer to query all transactions made from his site filtered by what ever he likes.
4. Purchases (see FIG. 5). The purchase tab contains three lists

(Denoted “1” in FIG. 5) Invoice list: contains all invoices sent by merchant's web sites and were not paid yet. By clicking on an invoice the payment window is opened enable the consumer to make the money transaction as described before

(Denoted “2” in FIG. 5) Entrance card list: This list is used to manage all content purchases. The content purchase process is the same as for a physical item, only the shipment step is different. In the case of content, the merchant's web site attached a link (that can be use only after the invoice is paid) to the invoice. After paying the invoice the link is added to the entrance card list. By clicking that link the consumer navigates to the content site without typing any user and password. (The link contains a payment recite)

(Denoted “3” in FIG. 5) Merchants' list: The consumer can create a list of favorite merchants or use a search engine such as shopping.com to provide him that list. By clicking a merchant from that list the consumer navigate to the merchant's web site (Step 2) with PCSite User name and a “disposable password” as parameters. On the check out process the merchant's web site send the invoice to the consumer site (Step 3) using the supplied password and PCSite user name, and all is left to do is to pay the bill (Step 4). All the interactions with the merchant site are made through the user personal site (See FIG. 6) most particularly a Money transaction history which completes the user side transparency, security, and convenience. The advertising banners, on the consumer site, functions the same way as the favorite merchants list.

The check out process includes only the payment window. In addition, as a result of the quick check out process, new business opportunity emerges. Content sites will be able to charge small amount of money (10c) for each entrance.

Now we will turn to Advanced Applications using the PCSite solution methods of the instant invention; specifically (1) to Transfer money using cellular devices, (2) to Communicate with the authorities, and (3) to Download Copyright protected files (e.g. .mp3).

Transfer money using cellular devices (with internet and IR abilities). This feature can be use as a replacement to electronic money or other kinds of smart cards. This feature will be explained by using a comparison chart wherein Person A is paying Person B amount of 100$ using their cell phones.

| Person A | Person B |
|---|---|
| Activate PCSite application on | Activate PCSite application on |
| the device | the device |
| Select option “Pay Money” | Select option “Receive Money” |
| Select PCSite User from a | Select PCSite User from a |
| pre-entered list as an account | pre-entered list as a deposit |
| to charge from. | account. |
| Identification by typing a | Enter the requested amount |
| valid password to the selected | of money (100$) |
| PCSite User. | |
| Enter the requested amount of | |
| money (100$) | |
| Transmit the data to PCSite | |
| Server and gets in return a | |
| disposable password that | |
| enable a sender to send an | |
| invoice of the exact amount. | |

At this point the IR communication between the two devices is
established.

| | |
|---|---|
| Transfer the PCSite User and | Receive the paying PCSite User |
| the disposable password via IR. | and a disposable password via IR |
| | Transmit a money transaction |
| | request from the paying PCSite User |
| | to the receiver (identification |
| | by the disposable password and |
| | the exact amount of money) |
| | Receive acknowledge massage from |
| | PCSite server. |

Communication with the authorities: PCSite can be use for all kind of formal communications between an individual and the authorities. Paying bills and taxes is one type of communication that PCSite system is design for and described in details above. Basically most of our communication with the authorities ends up with filling forms. Scenario 1—PCSite owner navigate to an authority site (IRS) and download to his site (Not to his machine) a requested form. Since PCSite contains all the personal details of its owner the form is filled in a flash. The consumer can now verified the data, update it if necessary (the update action will update PCSite database as well.) and by one click send the filled form back to IRS. Scenario 2—IRS can initiate a communication with an individual by sending to his PCSite a form to fill. In this case the PCSite owner will get a massage indicating him of the event and asking whether or not to fill it. If he chooses to fill the same actions described above take place.

Download Copyright protected files (e.g. .mp3): A consumer navigates from his PCSite to a download site (the PCSite User name and a disposable password are supply to the download site as parameters) and selects a file to download. When the download site receives a download request it sends an invoice to the PCSite user and display a message saying, “download will begin when payment will be done”. The consumer then focused on his PCSite browser by using alt+tab keys and pay the invoice just arrived. When the download site receives the payment the download process starts immediately.

Thus, the Internet today is becoming a working tool for more and more individuals that use the web for more and more reasons. Many of the web sites (especially the well establish ones) that supply services and information required registration or payment fees. By surfing the web through PCSite, the consumer is not anonymous anymore (his/hers PCSite user name and a disposable password are sent as parameters to each web site he/she visits). The advantage of that is efficient interaction between the consumer site and all other web sites, saving time and opening new opportunities.

Embodiments of the present invention also relates to a program storage device (and/or a physical memory media and/or a wireless carrier frequency transmission) that is readable by a machine, tangibly embodying a program of instructions executable by the machine to perform method steps and variations thereto substantially as hereinbefore described and illustrated. The program storage device and/or memory media need only computer readable and/or executable instructions providing to accomplish one or a combination of these steps or variations thereto—with the intention that they be used via an onboard, local, or remote telecommunications protocol—so that at least one other of the instant method steps of the instant invention be accomplished therewith.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I/We claim:

1. A Secure Internet E-Commerce Method, for improved consumer convenience managing of transactions, and the system includes:
(A) a secure Internet based website electronically facilitating Internet entry of an account-owner to a pre-registered account on the secure Internet based website;
(B) the secure Internet based website electronically escorting the owner to a merchant Internet site and therewith transmitting to the merchant site a one-time password, wherein said one-time password is thereafter identifiable by the secure Internet based website;
(C) the secure Internet based website electronically receiving an invoice from the merchant Internet site wherein said invoice includes the one-time password;
(D) the secure Internet based website electronically validating the one-time password;
(E) the secure Internet based website electronically presenting the invoice to the account owner; and
(F) if the secure Internet site receives an invoice approval from the owner, then the secure Internet site electronically providing the merchant Internet site with payment and delivery details necessary to complete a commercial agreement between the owner and the merchant wherein said agreement corresponds to specification, terms, and conditions associated with the invoice.

2. The Secure Internet E-Commerce Method according to claim 1 wherein electronically facilitating Internet entry of an account-owner to a pre-registered account on the secure Internet based website includes validating of an account owner password or of a biometric.

3. The Secure Internet E-Commerce Method according to claim 1 wherein electronically escorting the owner to a merchant Internet site includes the secure Internet based website electronically exchanging information with the merchant Internet site.

4. The Secure Internet E-Commerce Method according to claim 1 wherein transmitting the one-time password includes appending a data portion selected from the list: an account owner identifier, a password date stamp, a password expiration date, a password validity duration metric, an account owner profile, an account owner credit description, a secure Internet based website rebate descriptor, a secure Internet based website commission descriptor, a secure Internet based website transaction fee descriptor, and a secure Internet based website follow-up ID.

5. The Secure Internet E-Commerce Method according to claim 1 wherein receiving an invoice from the merchant Internet site includes receiving a transaction parameter portion selected from the list: a merchant Internet site identifier, an invoice date stamp, an invoice expiration date, an invoice validity duration metric, a merchant Internet site profile, merchant Internet site credit description, a merchant Internet site rebate descriptor, a merchant Internet site commission descriptor, a merchant Internet site transaction fee descriptor, and a merchant Internet site follow-up ID.

6. The Secure Internet E-Commerce Method according to claim 1 wherein electronically presenting the invoice to the account owner include electronically presenting a follow-up notice from a merchant site wherein the account owner has established a predetermined allowance to receive such a notice.

7. The Secure Internet E-Commerce Method according to claim 6 wherein electronically presenting a follow-up notice includes forwarding an email from the merchant to the account owner.

8. The Secure Internet E-Commerce Method according to claim 6 wherein electronically presenting a follow-up notice includes placing a merchant advertisement on an account owner WebPage of the secure Internet based website.

9. The Secure Internet E-Commerce Method according to claim 1 wherein providing the merchant Internet site with payment and delivery details necessary to complete a commercial agreement between the owner and the merchant includes providing account owner approved personal data or answering a merchant survey or answering a merchant satisfaction follow-up questionnaire.

10. The Secure Internet E-Commerce Method according to claim 1 wherein electronically escorting the owner to a merchant Internet site includes electronically accessing a real-time schedule of media content to media content rights merchant contact data—so that the owner can rent or purchase a copy of media content substantially as it was presented on a media selected from the list: transmission television, encrypted television, cable television, transmission radio, encrypted radio, cable radio, and cellular telephone data feed.

11. The Secure Internet E-Commerce Method according to claim 1 wherein electronically escorting the owner to a merchant Internet site includes electronically accessing a software content rights merchant's contact data—so that the owner can rent or purchase a copy of software content, executable code, or data usable therewith.
